(19) United States
(12) Patent Application Publication
(10) Pub. No.: US 2021/0042890 A1
(43) Pub. Date: Feb. 11, 2021

(54) Adaptive Tiles for Geometric Correction

(71) Applicant: NXP USA, Inc., Austin, TX (US)

(72) Inventors: Sharath Subramanya Naidu, Munich (DE); Ajit Singh, Delhi (IN); Michael Andreas Staudenmaier, Munich (DE)

(73) Assignee: NXP USA, Inc., Austin, TX (US)

(21) Appl. No.: 16/531,370

(22) Filed: Aug. 5, 2019

(51) Int. Cl. G06T 5/00; G06T 1/60

(52) U.S. Cl. CPC G06T 5/006; G06T 1/60

(57) ABSTRACT

A system, method, and apparatus are provided for correcting image distortions in an image processing hardware unit by specifying an input block having a dynamic or adaptive size that is capable of storing up to a plurality of distorted input sub-images from an array of distorted input sub-images stored in external memory that is connected to the image processing hardware unit, and then fetching one or more first distorted input sub-images from the external memory for storage in internal memory of the image processing hardware using the input block to perform a single read operation so that the image processing hardware can then process the one or more first distorted input sub-images as a group for distortion correction to generate a one or more first corrected output tiles.

### BACKGROUND OF THE INVENTION

### Field of the Invention

The present invention is directed in general to field of image processing. In one aspect, the present invention relates to an apparatus, system and method for tile-based distortion correction techniques transforming a distorted image into a non-distorted image.

### Description of the Related Art

Computer vision systems are increasingly used in different applications (e.g., Advanced Driver Assistance System (ADAS), surveillance, inspection, security, and remote sensing systems), as well as mainstream applications (e.g., consumer digital imaging and real time video conferencing). In such applications, image distortion can result from distortions in the optical camera system, causing warping or transformation of an object and its surrounding area in an image. For example, there are geometric distortions, such as barrel distortion or pincushion distortion, that result from distortions in a lens design. In addition, Wide Field of View (WFOV) lens systems can introduce non-uniform distortion patterns across the field of view so that acquired images (or different color planes of an acquired image) do not uniformly conform to the ideal non-distorted image mapping. For applications where image distortion is not desired, distortion correction processing may be applied to digitally correct a distorted input image, such as by applying a remapping process. However, such remapping solutions are computationally intensive since they typically require looking, for each pixel in the corrected image (target pixel), the source position from the input image where the source pixel originates and then interpolating the surrounding source pixels accordingly. As can be seen, such remapping solutions are computationally inefficient in requiring reading each source pixel multiple times. To the extent such duplicative processing of the source pixels imposes memory access requirements for each processing iteration, there are also system costs imposed in the form of memory space requirements and/or the bandwidth requirements for transferring enormous amounts of information across the system bus at high frame acquisition speeds. As seen from the foregoing, the existing solutions for quickly and efficiently performing image distortion correction processing are extremely difficult at a practical level by virtue of the challenges with meeting the performance requirements for allowing real time and reliable configuration of devices in minimal time using turnaround and reverse high speed communication.

### BRIEF DESCRIPTION OF THE DRAWINGS

The present invention may be understood, and its numerous objects, features and advantages obtained, when the following detailed description of a preferred embodiment is considered in conjunction with the following drawings.

FIG. 1 depicts a system block diagram of a geometric correction unit and an external memory for performing tile-based image distortion correction processing in accordance with selected embodiments of the present disclosure.

FIG. 2 depicts a distorted input sub-image stored in local memory for geometric distortion correction processing to correct for geometric distortions in the input image.

FIG. 3 depicts a plurality of distorted input sub-images stored in local memory for geometric distortion correction processing in accordance with selected embodiments of the present disclosure.

FIG. 4 depicts a distorted input image stored in external memory along with a plurality of input blocks for sequentially loading distorted input sub-images into local memory based on a specified tile size grouping in accordance with selected embodiments of the present disclosure.

FIG. 5 depicts a distorted input image stored in external memory along with a plurality of adaptively sized input blocks for sequentially loading distorted input sub-images into local memory based on a predetermined sub-image grouping in accordance with selected embodiments of the present disclosure.

FIG. 6 schematically depicts a block diagram of a computer system in accordance with selected embodiments of the present disclosure.

FIG. 7 depicts a simplified flow chart showing the logic for processing groups of distorted image sub-images in accordance with selected embodiments of the present disclosure.

### DETAILED DESCRIPTION

An apparatus, system, architecture, methodology, and program code are described for using adaptive sub-images to perform geometric distortion correction by loading internal memory with adaptively sized input blocks which are sized to capture multiple input sub-images for distortion processing together as a block, thereby improving device performance, increasing efficiency of internal memory usage, and reducing bandwidth requirements for mapping multiple input image sub-images stored in external memory. In selected embodiments, the adaptively sized input blocks are configured offline as a set of descriptors which are used by distortion correction hardware to specify how many input sub-images fit into the internal memory. In operation, a hardware-based geometric correction unit processes distorted input sub-images stored in external memory by using a configurable input block to fetch multiple distorted input sub-images for storage in internal memory, such as an embedded buffer. In selected embodiments, the adaptively sized input block has a minimum size that is suitable for fetching at least one input sub-image at the image center which usually has the most distortion, but preferably multiple input sub-images, from the input frame so that the number of output tiles may be adaptively selected for distortion correction processing together, depending on the density of the source area in the input image. In other embodiments, the adaptively sized input block has an adaptable size that is suitable for fetching one or more multiple input sub-images from the input image and that may be optimized to reduce overlapping pixel reads from the input image. By using the (adaptive) configurable input block to maximize the number of input sub-images fetched from external memory while minimizing the pixel overlap processing based on the current area of the input image, the bandwidth requirements for external memory accesses are reduced.

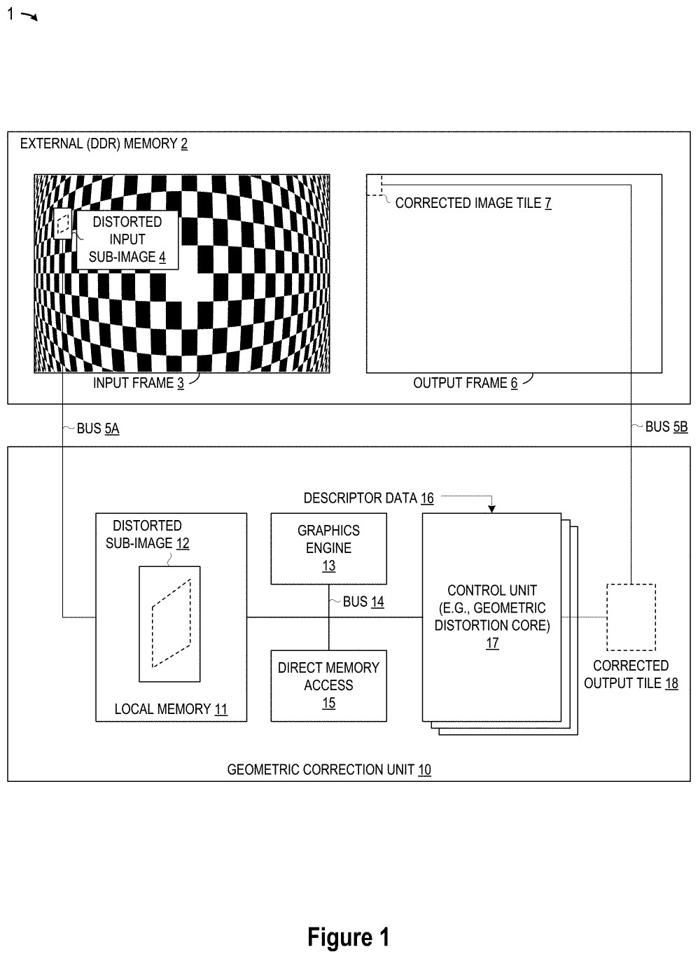

To provide additional details for an improved contextual understanding of the present disclosure, reference is now made to FIG. 1 which depicts a system block diagram 1 of geometric correction unit 10 that is connected to an external memory 2 over a memory bus 5A/B to perform tile-based image distortion correction processing. In selected embodiments, the geometric correction unit 10 may be implemented as a dedicated IP block which digitally corrects geometric distortions in the input image with a remapping process that transforms the pixels of a distorted image in an input frame 3 from one projection to another projection for storage as the corrected image in the output frame 6. In an example remapping process, the geometric correction unit 10 divides the corrected image in the output frame 6 into a series of output grids or tiles, and then reads into the local memory 11 the source data sub-images (from the input frame 3) required to generate the output grids/tiles one after another for remapping. To support the remapping process, the external memory 2 stores the distorted input image as input frame image 3 which contains a grid of source sub-images 4, where each sub-image may be defined by its vertices or “nodes” (e.g., the four corners of a distorted sub-image).

Connected over a memory bus 5A, the geometric correction unit 10 is configured to fetch distorted sub-images from external memory 2 for storage in local memory 11 as distorted sub-images 12, and to transform or map the coordinates of nodes within a grid according to a given distortion to be corrected into a corrected image tile 7 for storage as an output frame image 6 in external memory 2. In an example embodiment, the geometric correction unit 10 may be embodied as an geometrical distortion engine for handling geometrical distortion in a digital image acquisition device, and may include a local or embedded memory 11, a graphics engine 13, a direct memory access (DMA) unit 15, and a control unit 17 connected over a system bus 14 to remove distortions introduced by a camera input lens system. The control unit 17 may be configured to process an input image frame 3 sub-image by sub-image under the control of a graphics engine 13 by fetching distorted input sub-images 4 from external memory 2 according to the addresses provided by the graphics engine 13 for storage in local memory 11 as distorted sub-images 12 which are then processed by the control unit 17 to produce corrected image pixels for respective output tiles 18 in normal raster order. In selected embodiments, the graphics engine 13 combines local grid information taken from external memory 2 along with a transformation matrix to produce distortion descriptor data for each sub-image of the grid from an input image frame which is to be processed by the geometric correction unit 10. These descriptors may be employed by the control unit 17 to read correct image tile information from memory and to correct the sub-image. In the control unit 17, distortion correction can be performed by mapping of each pixel with radius r in the image to a pixel with radius p in the corrected image, where the pixel m(u, v) is mapped to m(u0, v0) in the corrected image. Hence, a look-up table (LUT) can be created which maps the position of each pixel in the input image to a pixel in the output distortion-corrected image. The control unit 17 may invoke the DMA 15 to read corresponding LUT of the input image sub-image 4 from external memory 2 into the local memory 11. The geometric distortion correction core/control unit 17 uses this LUT to read required pixels from the local memory 11 and corrects the image. At the control unit, distortion correction processing is applied to each sub-image, such as by employing a direct remapping process to identify, for each target pixel in the corrected image 6, the source pixel position in the input image frame 3 (source position) and to interpolate the surrounding source pixels accordingly, thereby requiring that each source pixel is read many times in the remapping process.

In addition, the geometric correction unit 10 may perform distortion processing independently on each color plane of an image (e.g., RGB, YUV or LAB) by implementing the control unit 17 with one or more geometric distortion cores (GDC) that are configured to process each color plane separately and/or to process each color plane sequentially so as to process multiple planes of an image separately and/or at the same time. In addition, the geometric correction unit 10 may include an output formatter (not shown) which may be configurable and which can write corrected image tiles 18 into output images in bursts back to the external memory 2. If desired, additional output tile processing can be applied to generate the corrected output image tile 18 with a standard output frame format so that each tile output by the control unit 17 can be treated as a separate image.

Conventionally, only the information required for correcting a given distorted input sub-image is read from external memory 2 into the local memory 11 of the geometric correction unit 11. For example, existing distortion processing approaches will separately process each tile in the destination image (e.g., a rectangular patch of 64×64 pixels) in one shot by prefetching the required source data from external memory 2. While this approach significantly reduces the bandwidth requirements over the memory bus 5A/B as compared to fetching the entire frame 3, there are still overhead requirements that remain for the boundaries of the sub-image where pixels usually must be re-fetched one or more times. In particular, the non-linear distortion of the input image means that the size of the area that has to be read in order to generate a destination tile is not constant. As a result, the information for each distorted sub-image 4 of the input image frame 3 may be read with rectangular input blocks which bound the distorted sub-image 4 with additional, surrounding source pixels. For heavily distorted input image sub-images, this can require reading a significant number of source pixels from external memory 2 across the system bus 5A that are not used in mapping the distorted input image sub-image 4 to the corrected image output image tile 7. Thus, tile-based geometric correction requires either a significant amount of internal memory or consumes a significant bandwidth of the memory bus 5A/B for both read and writes operations, especially with duplicative processing of source pixels. These two factors (internal memory size and external bandwidth consumption) are significant cost factors that can, within limits, be traded-off against each other. For example, the required size of the internal or local memory 11 must be at least large enough to store the largest single sub-image from the input frame 3 having the highest pixel density, which is usually located the center of the input frame 3.

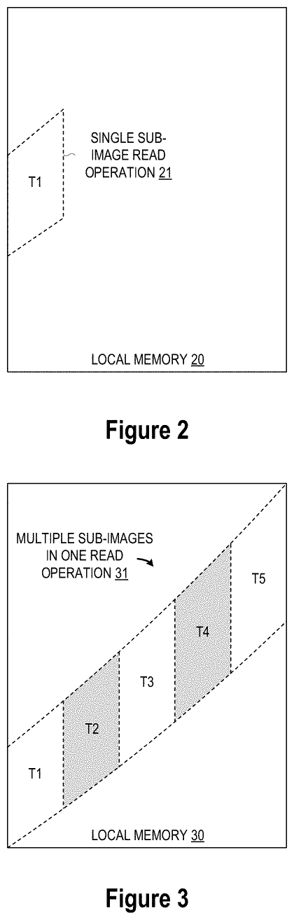

To provide additional details for an improved understanding of the present disclosure, reference is now made to FIG. 2 which depicts a distorted input sub-image T1 stored in local memory 20 for remapping or transformation to correct for geometric distortions. In the depicted example, the dashed lines are the boundary pixels of a single distorted input sub-image T1 which is stored in the local memory 20 using a single sub-image read operation 21. As illustrated, the storage of the single sub-image T1 results in a significant portion of the expensive local memory 20 being unused or wasted. In addition, there is system overhead and memory bus bandwidth consumed with each single sub-image-read operation 21, thereby limiting the overall system efficiency and increasing the cost of such distortion correction solutions.

To address these limitations and others that will be apparent to persons skilled in the art, there is disclosed herein an apparatus, system, architecture, methodology, and program code for performing tile-based distortion correction using local embedded buffer or memory to adaptively store the maximum number of distorted input sub-images allowed by the pixel density/distortion for distortion correction processing together, thereby increasing system efficiency by reducing system overhead and memory bus bandwidth consumption. To illustrate selected embodiments of the disclosed solutions, reference is now made to FIG. 3 which depicts a plurality of distorted input image sub-images T1-T5 stored in local memory 30 for geometric distortion correction processing. In the depicted example, the expensive local memory 30 is defined with a minimum required memory size to meet the largest required distorted sub-image size and highest pixel density (e.g., the distorted sub-images at the center of the input image frame). Given the minimum required memory size, external memory fetch operations may be controlled to load the internal memory 30 with source data for multiple distorted input sub-images T1-T5 for areas of the input image frame where this is possible. As a result, the dashed lines are the boundary pixels of a plurality of distorted input sub-images T1-T5 which are stored in the local memory 30 using a single read operation 31 to make better use of the expensive local memory 30. Depending upon the type of distortion introduced by the camera input lens, the ability to read multiple distorted input sub-images T1-T5 will work better in certain parts of the input image frame (e.g., the outer areas of the image) than in other areas (e.g., the center of the image) where the source data for only a single sub-image will fit into the local memory 30. However, for areas of the input image frame where multiple input sub-images can fit in the minimum required memory size, the internal memory can be used to store and process multiple output tiles in one shot with significantly reduced external bandwidth consumption.

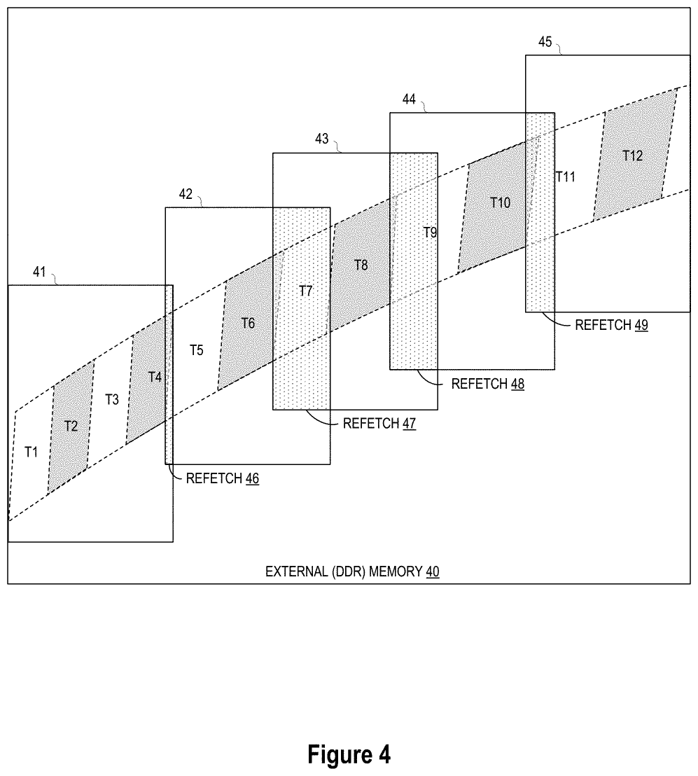

To provide additional details for an improved understanding of selected embodiments of the present disclosure, reference is now made to FIG. 4 which depicts a plurality of distorted input sub-images T1-T12 from an input image stored in external memory 40 along with a plurality of input blocks 41-45 for sequentially loading distorted input sub-images into local memory based on a sub-image grouping. As depicted, each input block 41-45 has a fixed or uniform size which corresponds to the available size of the local memory so that one or more input sub-images may be loaded into internal memory. For example, a first input block 41 may be used to fetch a first set of input sub-images (T1-T4) from external memory 40 upon determining that the corresponding source data for the sub-images T1-T4 will fit within the input block 41. However, since the source data for input sub-image T5 did not fit in the first input block 41, a second input block 42 is used to fetch a second set of adjoining input sub-images (T5-T6) from external memory 40 which have source data that will fit within the input block 42 (and therefor will fit in local memory). Similarly, a third input block 43 is used to fetch a third set of adjoining input sub-images (T7-T8) from external memory 40 which have source data that will fit within the input block 43, a fourth input block 44 is used to fetch a fourth set of input sub-images (T9-T10) which will fit within the input block 44, a fifth input block 45 is used to fetch a fifth set of input sub-images (T11-T12) which will fit within the input block 45, and so on. As demonstrated with this example, the input blocks 41-45 are applied to adjoining distorted sub-images to adaptively read the number of distorted input sub-images with a single read operation which will fill the local memory to the maximum allowed by the pixel density/distortion.

While system efficiency is improved by using input blocks 41-45 to fetch multiple sub-images for local memory storage (as compared to filling the local memory per output tile), the use of fixed size input blocks 41-45 results in source data pixels which are overlapped by successive input blocks. As a consequence, there is duplicative memory fetch processing at the identified refetch zones 46-49. For example, there is a first refetch zone 46 defined by the overlap between the first and second input blocks 41, 42 where source data pixels are fetched at least twice. Similarly, overlapping source data pixels are refetched in the second refetch zone 47 (defined by the overlap between the second and third input blocks 42, 43), in the third refetch zone 48 (defined by the overlap between the third and fourth input blocks 43, 44), and the forth refetch zone 49 (defined by the overlap between the fourth and fifth input blocks 44, 45).

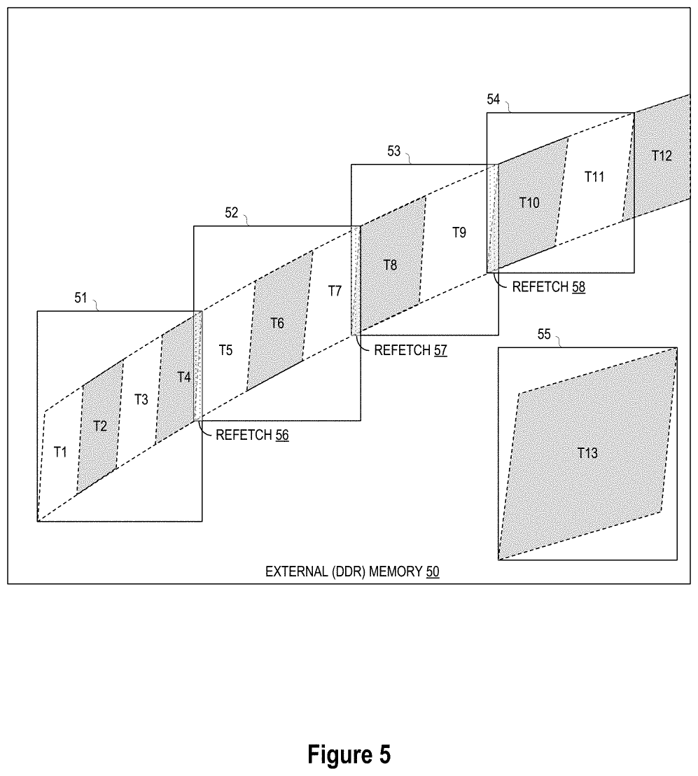

To reduce or minimize operational inefficiencies from processing overlapping source data pixels, selected embodiments of the present disclosure provide an apparatus, system, architecture, methodology, and program code for performing tile-based distortion correction by adaptively adjusting the size of the input blocks used to fetch distorted input sub-images from external memory for storage in the local embedded buffer or memory. To illustrate selected embodiments of the disclosed solutions, reference is now made to FIG. 5 which depicts a plurality of distorted input sub-images T1-T13 from an input image stored in external memory 50 along with a plurality of adaptively sized input blocks 51-55 for sequentially loading distorted input image sub-images into local memory based on a predetermined sub-image grouping. As depicted, each input block 51-55 is adaptively sized to correspond to the maximum number of distorted input sub-images that will fit in the local memory so that one or more input sub-images may be loaded into internal memory. Thus, each input block 51-55 has a configurable size that is no bigger than the size of the internal memory, and that is no smaller than a size that is sufficient to contain the largest distorted input sub-image from the input image frame or a plurality of smaller distorted input sub-images, whichever is smaller.

For example, a first input block 51 having a first configurable size may be used to fetch a first set of input sub-images (T1-T4) from external memory 50 upon determining that the corresponding source data for the input sub-images T1-T4 will fit within the input block 51. In this case, the size of the first input block 51 is smaller than the size of the internal memory and is also slightly smaller than the size of the input block 55 that contains the largest distorted input sub-images T13 from the input image frame, but is configured to be large enough to contain the maximum number of complete distorted input sub-images (e.g., T1-T4) that can be stored in internal memory. In configuring the size of the input block 51, the height and width are controlled to contain the entirety of the distorted input sub-images T1-T4 without any excess room in the height and width dimensions.

In similar fashion, a second input block 52 has a second configurable size for use to fetching a second set of adjoining input sub-images (T5-T7) from external memory 50 which have source data that will fit within the second input block 52. In this example, the second input block 52 is slightly shorter and wider than the size of the first input block 51 and also smaller (in width and height) than the input block 55 that contains the largest distorted input sub-image T13, but is configured to be large enough to contain the maximum number of complete distorted input sub-images (e.g., T5-T7) that can be stored in internal memory. Again, the configured size of the input block 52 has a height and width that are controlled to contain the entirety of the distorted input T5-T7 without any excess room in the height and width dimensions. As a consequence of adaptively sizing the input blocks 51, 52, there is a reduction of duplicative memory fetch processing of source data pixels. This is illustrated with the refetch zone 56 which shows the source data pixels which are overlapped between the first and second input blocks 51, 52.

In addition, a third input block 53 having a third configurable size is used to fetch a third set of adjoining input sub-images (T8-T9) from external memory 50 which have source data that will fit within the input block 53. In this example, the third input block 53 is shorter and narrower than the size of the first input block 51 and the input block 55 that contains the largest distorted input T13, but is configured to be large enough to contain the maximum number of complete distorted input sub-images (e.g., T8-T9) that can be stored in internal memory. By configuring the size of the input block 53 with a height and width to contain the entirety of the distorted input sub-images T8-T9 without any excess room in the height and width dimensions, there is a reduction of duplicative memory fetch processing of source data pixels, as illustrated with the refetch zone 57 which shows the source data pixels which are overlapped by the input blocks 52, 53.

Finally, a fourth input block 54 having a fourth configurable size is used to fetch a fourth set of adjoining input sub-images (T10-T11) which will fit within the input block 54, and so on. In the example of the fourth input block 54, it is shorter and narrower than the size of the first input block 51 and the input block 55, but is configured to be large enough to contain the maximum number of complete distorted input sub-images (e.g., T10-T11) that can be stored in internal memory. By configuring the size of the input block 54 with a height and width to contain the entirety of the distorted input sub-images T10-T11 without any excess room in the height and width dimensions, there is a reduction of duplicative memory fetch processing of source data pixels, as illustrated with the refetch zone 58 which shows the source data pixels which are overlapped by the input blocks 53, 54.

As demonstrated with this example of FIG. 5, the input blocks 51-56 are each configured with adaptive sizes to fit the maximum number of adjoining distorted sub-images that can be stored in internal memory with minimal wasted space. By adaptively sizing each input block to fetch the maximize the number of distorted sub-images allowed by the pixel density/distortion and internal memory size while minimizing the amount of source data pixels fetched for internal memory, multiple distorted sub-images can be fetched from external memory with a single read operation and processed as a group to improve system efficiency, reduce bandwidth consumption, minimize overhead, and minimize costs.

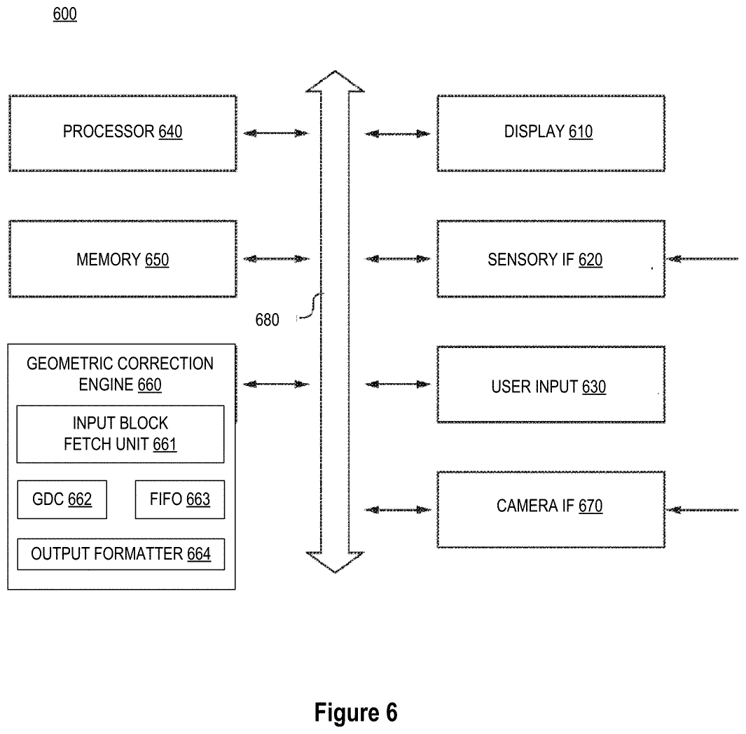

To provide additional details for an improved understanding of selected embodiments of the present disclosure, reference is now made to FIG. 6 which schematically depicts a block diagram of a computer system 600 in which multi-tile geometric distortion correction may be implemented. As depicted, the computer system 600 can be implemented as or incorporated into various devices, such as various types of vehicle computer systems (e.g., Electronic/Engine Control Module, Powertrain Control Module, Transmission Control Module, Brake Control Module), a personal computer (PC), a tablet PC, a set-top box (STB), a personal digital assistant (PDA), a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that machine. The computer system 600 may be implemented using electronic devices that provide voice, audio, video or data communication. While a single computer system 600 is illustrated, the term “system” may include any collection of systems or sub-systems that individually or jointly execute a set, or multiple sets, of instructions to perform one or more computer functions. As described hereinbelow, the computer system 600 may include a set of instructions that can be executed to cause the computer system 600 to perform any one or more of the methods or computer-based functions disclosed.

The depicted computer system 600 may include a processor 640, such as a central processing unit (CPU), a graphics processing unit (GPU), or both. The processor 640 may be a component in a variety of systems. The processor 640 may be one or more general processors, digital signal processors, application specific integrated circuits, field programmable gate arrays, servers, networks, digital circuits, analog circuits, combinations thereof, or other now known or later developed devices for analyzing and processing data. The processor 640 may have a multi-core processor design. The processor 640 may implement a software program, such as code generated manually or programmed.

The term “module” may be defined to include a number of executable modules. The modules may include software, hardware or some combination thereof executable by a processor, such as processor 640. Software modules may include instructions stored in memory, such as memory 650, or another memory device, that may be executable by the processor 640 or other processor. Hardware modules may include various devices, components, circuits, gates, circuit boards, and the like that are executable, directed, and/or controlled for performance by the processor 640.

The computer system 600 may include a memory, such as a memory 650 that can communicate via a bus 680. The memory 640 may be a main memory, a static memory, or a dynamic memory. The memory 650 may include, but is not limited to computer readable storage media, such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory 650 includes a buffer memory (e.g., an internal FIFO buffer memory), a cache, or random access memory for the processor 640. In alternative examples, the memory 650 may be separate from the processor 640, such as a cache memory of a processor, the system memory, or other memory. The memory 650 may include a disk or optical drive unit, an external storage device or database for storing data. Examples include a hard drive, compact disc (“CD”), digital video disc (“DVD”), memory card, memory stick, floppy disc, universal serial bus (“USB”) memory device, or any other device operative to store data. The memory 650 is operable to store instructions executable by the processor 640. The functions, acts or tasks illustrated in the figures or described may be performed by the programmed processor 640 executing the instructions stored in the memory 650. The functions, acts, or tasks may be independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

A computer readable medium or machine readable medium may include any non-transitory memory device that includes or stores software for use by or in connection with an instruction executable system, apparatus, or device. The machine readable medium may be an electronic, magnetic, optical, electromagnetic, infrared, or semiconductor system, apparatus, or device. Examples may include a portable magnetic or optical disk, a volatile memory such as Random Access Memory “RAM”, a read-only memory “ROM”, or an Erasable Programmable Read-Only Memory “EPROM” or Flash memory. A machine readable memory may also include a non-transitory tangible medium upon which software is stored. The software may be electronically stored as an image or in another format (such as through an optical scan), then compiled, or interpreted or otherwise processed.

As will be appreciated, the term “computer readable medium” may include a single medium or multiple media, such as a centralized or distributed database, and/or associated caches and servers that store one or more sets of instructions. The computer readable medium may also include any medium that is capable of storing, encoding or carrying a set of instructions for execution by a processor or that cause a computer system to perform any one or more of the methods or operations disclosed. The computer readable medium may be non-transitory, and may be tangible. In addition, the computer readable medium may include a solid-state memory, such as a memory card or other package that houses one or more non-volatile read-only memories. The computer readable medium may be a random access memory or other volatile re-writable memory. The computer readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. The computer system 600 may include any one or more of a computer readable medium or a distribution medium and other equivalents and successor media, in which data or instructions may be stored.

The computer system 600 may include a geometric correction engine 660. In selected embodiments, the geometric correction engine 660 may include an input block fetch unit 661, geometric distortion control hardware logic 662, an internal first-in-first out (FIFO) memory 663, and an output formatter 664. As described herein, the geometric correction engine 660 fetches input sub-images from external memory 650 according to the addresses provided by the input block fetch unit 661 and processes them at the geometric distortion control hardware logic 662 to produce corrected pixels for respective output tiles which the output formatter 664 writes back to external memory 650 in normal raster order. In selected embodiments, the geometric correction engine 660 may include hardware, firmware, and/or a computer readable medium in which one or more sets of instructions or software can be embedded for performing one or more of the methods or logic described herein for adaptively sizing the memory fetch input blocks to fit the maximum number of adjoining distorted sub-images that can be stored in internal memory with minimal wasted space.

The computer system 600 may or may not further include a display unit 610, such as a liquid crystal display (LCD), an organic light emitting diode (OLED), a flat panel display, a solid state display, a cathode ray tube (CRT), a projector, a printer or other now known or later developed display device for outputting determined information. The display 610 may act as an interface for the user to see the functioning of the processor 640, or specifically as an interface with the software stored in the memory 640 or in the geometric correction engine 660.

The computer system 600 may also include one or more input devices. For example, a sensory interface unit 620 may be connected to convey sensor input signals over the bus 680 for processing by the processor 640, geometric correction engine 660, and/or instructions stored in memory 650. In addition, the computer system 600 may include an input device 630 configured to allow a user to interact with any of the components of system 600. The input device 630 may be a number pad, a keyboard, or a cursor control device, such as a mouse, or a joystick, touch screen display, remote control or any other device operative to interact with the computer system 600. The computer system 600 may also include a communication port or interface 670 to receive image data from the plurality of cameras of the surround view vision system. The image data may be written frame-wise to the memory 650 via the bus 680.

In selected embodiments, the geometric correction engine may be implemented with dedicated hardware, such as application specific integrated circuits, programmable logic arrays and other hardware devices, may be constructed to implement various parts of the system. Applications that may include the apparatus and systems can broadly include a variety of electronic and computer systems. One or more examples described may implement functions using two or more specific interconnected hardware modules or devices with related control and data signals that can be communicated between and through the modules, or as portions of an application-specific integrated circuit. The computer system 600 encompasses software, firmware, and hardware implementations. The system described may be implemented by software programs executable by a computer system. Implementations can include distributed processing, component/object distributed processing, and parallel processing. Alternatively, virtual computer system processing can be constructed to implement various parts of the system.

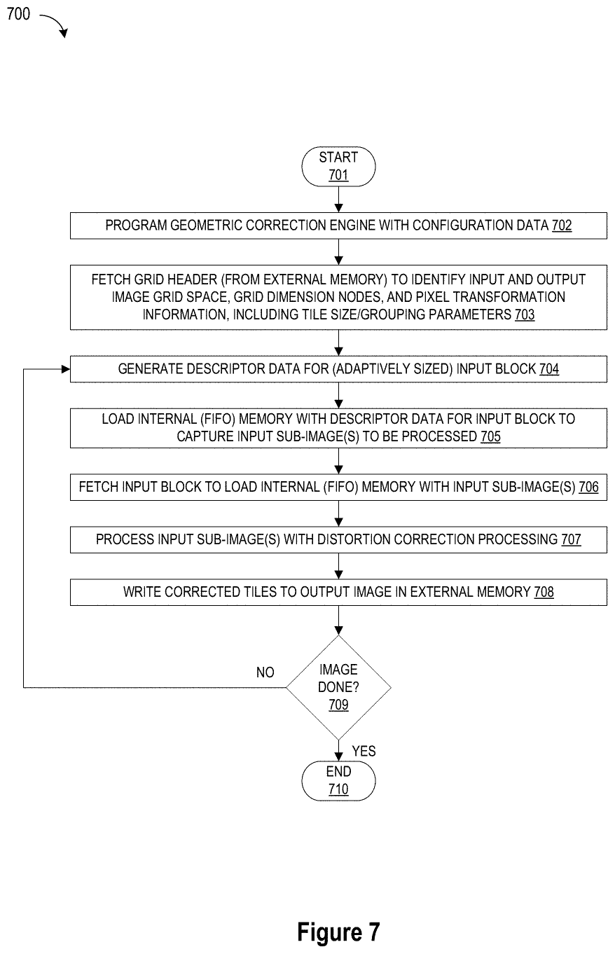

To provide additional details for an improved understanding of selected embodiments of the present disclosure, reference is now made to FIG. 7 which depicts a simplified flow chart diagram 700 showing the logic for processing groups of distorted image sub-images, such as may be used by a geometric correction unit and/or computer system. In the flow diagram 700, the method starts at step 701 when the distortion correction is computed for the geometric distortion correction processing, including controlling the input sub-images grouping used to fetch input sub-images from external memory. For example, the distortion correction may be pre-calculated at the computer system 600 and provided to the geometric correction engine 660 to specify the grouping of sub-images fetched from external memory during distortion correction processing and/or to fetch the LUT which contains remapping coordinates.

At step 702, the geometric correction engine is programmed with configuration data for the distortion correction processing. In selected embodiments, a computer system processor (e.g., CPU 640) may be configured to program the input block fetch unit 661 and the other blocks in the geometric correction engine to allow the number of output tiles to be adaptively chosen depending on the density of the source area (i.e., region of the image).

At step 703, the geometric correction engine retrieves information from external memory specifying the input image transformation data to be processed for distortion correction, such as by fetching grid header information from the external memory to identify the input and output image grid space, grid dimension nodes, and pixel transformation information, including tile size and grouping parameters which specify the size constraints on the input blocks used to fetch input sub-images from external memory. As disclosed herein, the sub-image size/grouping parameters may specify dimensional information (e.g., height and/or width) for the maximum size of an input block so that sub-image block fetch operations fit within the internal (FIFO) memory of the geometric correction engine. In addition, the sub-image size/grouping parameters may specify dimensional information (e.g., height and/or width) for the minimum size of an input block so that sub-image fetch operations can store the largest single distorted input sub-image size and highest pixel density.

In selected embodiments, the grid header information contains information about grid location in the output image space, the grid dimension expressed in number of nodes, and sub-image size and grouping information used to specify the size of the input blocks used to fetch sub-images from external memory. For example, the output image grid may be rectangular and formed with an array of corrected, rectangular output tiles that are assembled in the output image space. The grid dimension nodes may include coordinates in the input image space, and the pixel transformation information may specify variations in those coordinates which describe the distortion associated with the local grid input image.

For example, local grid transformation values fetched at step 703 may define, for each node of the local grid, the change in node coordinate information. In this way, the local grid transformation values can compensate for varying distortions caused by changes in perspective for different local regions within an input image. In addition, the local grid transformation values can help to compensate for different degrees of distortion located in different areas of the input image. After fetched values from the grid header are stored in setup registers, the geometric correction engine may use these values to access the local grid information from external memory to retrieve pixel transformation information. To account for input camera lens distortion, the pixel transformation information may be provided using a look-up table (LUT) which contains mapping information to map node coordinates from the input image to the output image. With pixel transformation values for a given node coordinate and nodes surrounding that location in the input image, the geometric correction engine may interpolate the mapping of nodes in one or more input sub-images to a node of a corrected output tile. In addition, the geometric correction engine may sequentially read transformation coefficients for each node from external memory for local storage and application to corresponding source pixels from the input image. If desired, the geometric correction engine may apply one or more transformations to the locally stored transformation coefficients, including but not limited to a global affine transformation that is applied to all local grids of an input image frame, a local affine transformation that is applied to selected local grids of an input image frame, a global warping correction transformation, and the like.

At step 704, the geometric correction engine generates input block descriptors to specify information for the distorted input sub-images to be fetched from external memory for storage in the internal memory of the geometric correction engine. As disclosed herein, the retrieved grid header information may be used to sequentially define input blocks which can retrieve the maximum number of distorted input sub-images with a single fetch operation, given the maximum and minimum size requirements for the input block specified by the tile size/grouping parameters. In selected embodiments, the disclosed input blocks are defined as a quadrilateral input block with a fixed size that is sufficient to store at least the largest single distorted input sub-image positioned in a first location of the input frame (e.g., the center location which is usually the biggest single tile in the input image), while also being sized sufficiently to store multiple distorted input sub-images positioned in other locations of the input frame. In other embodiments, the disclosed input blocks are adaptively defined as quadrilateral input blocks with an adjustable size that is optimized to store the largest single distorted input sub-image positioned in the first (e.g., center) location of the input frame, and that is also adaptively optimized to store multiple distorted input sub-images positioned in other locations of the input frame, thereby minimizing duplicative source pixel processing from overlapping fetch operations.

At step 705, the internal memory is loaded with the input block descriptor data to capture one or more input image sub-images in the input block for processing. As disclosed herein, the geometric correction engine may use the input block fetch unit to prepare descriptor data that contains a full definition of one or more distorted input sub-images that will be fetched with each defined input block. The definition contains the location of one or more sub-images on the sensor image stored in external memory that will fit within the input block for retrieval and distortion correction processing at the geometric correction engine.

At step 706, the input block is fetched from external memory to load the internal memory with one or more input sub-images. Depending on the size of the input block, the geometric correction engine may fetch one or more distorted input sub-images for storage in the internal FIFO memory using a single read operation to external memory. As disclosed herein, the fetch operations are optimized to read the maximum number of input sub-images that can fit within the internal FIFO memory of the geometric correction engine.

At step 707, the geometric correction engine applies distortion correction processing to the distorted input sub-image(s) stored in internal memory. In selected embodiments, the processing at step 707 outputs corrected in frame interface format. If desired, additional processing algorithms can be applied on the corrected tiles.

At step 708, the corrected tiles are written to the output image in external memory. In selected embodiments, the geometric correction engine may generate an interrupt signal to an interrupt controller when distortion correction processing of an input image frame is completed. At step 708, the output tiles are written continuously as and when they are generated until end of frame.

At step 709, it is determined if distortion correction processing of the entire input image is completed. If distortion correction processing of the entire input image is not completed (negative outcome to detection step 709), then the sequence of steps 704-708 is repeated to reposition (and resize) the input block until all the distorted input sub-images from the input image are processed (affirmative outcome to detection step 709), at which point the method stops (step 710).

By now it should be appreciated that there has been provided an apparatus, method, program code, and system for correcting image distortions in an image processing hardware unit that is connected to external memory which stores a geometrically distorted image as an input image frame that is divided into an array of distorted input sub-images. In the disclosed embodiments, the image processing hardware unit specifies an input block having a configurable size that is capable of storing up to a plurality of distorted input sub-images from the array of distorted input sub-images stored in external memory. In selected embodiments, the input block is specified by generating descriptor data for the input block. In other embodiments, the input block is specified to have a fixed size that is sequentially applied to fetch adjoining groups of distorted input sub-images from external memory. In other embodiments, the input block is specified to have an adaptive size that is sequentially applied to fetch adjoining groups of distorted input sub-images from external memory with minimal overlap between different fetch operations. In addition, the image processing hardware unit fetches one or more first distorted input sub-images from the external memory using the input block to perform a single read operation to fetch the one or more first distorted input sub-images. In selected embodiments, multiple distorted input sub-images are fetched from external memory using the input block. In other embodiments, a largest single distorted input sub-image is fetched from external memory using the input block. The image processing hardware unit also stores the one or more first distorted input sub-images in internal memory of the image processing hardware. Finally, the image processing hardware processes the one or more first distorted input sub-images as a group for distortion correction to generate a one or more first corrected output tiles. In selected embodiments, the first distorted input sub-images are processed by remapping source data pixels in the one or more first distorted input sub-images as a single group for distortion correction

In another form, there has been provided an apparatus, method, program code, and system for correcting image distortions. In the disclosed embodiments, the image processing system includes an external memory which stores a geometrically distorted image in a source frame as an array of distorted input sub-images, and which also stores a corrected image in an output frame as an array of corrected output tiles. In addition, the disclosed image processing system includes an image processing hardware unit connected to the external memory, where the image processing hardware unit includes a control unit and an internal memory that is smaller than the external memory. As disclosed, the control unit is configured to read source data from the source frame in external memory for storage in internal memory using an input read block having an adaptive size for retrieving up to a plurality of distorted input sub-images with a single read operation. In selected embodiments, the control unit is configured to specify the adaptive size of the input read block by generating descriptor data for the input read block. In other embodiments, the control unit is configured to specify the adaptive size of the input read block by specifying a fixed size for the input read block that is sequentially applied to fetch adjoining groups of distorted input sub-images from external memory. In other embodiments, the control unit is configured to specify the adaptive size of the input read block by specifying an input read block having an adaptive size that is sequentially applied to fetch adjoining groups of distorted input sub-images from external memory with minimal overlap between different fetch operations. In operation, the control unit may be configured to fetch multiple distorted input sub-images from external memory using the input read block, or may be configured to fetch a largest single distorted input sub-image from external memory using the input read block. In addition, the control unit is configured to use the input read block to fetch and process one or more first distorted input sub-images as a group for distortion correction to generate a one or more first corrected output tiles for storage in the output frame of external memory. In selected embodiments, the control unit may be configured to process one or more first distorted input sub-images by remapping source data pixels in the one or more first distorted input sub-images as a single group for distortion correction.

In yet another form, there has been provided an electronic device, apparatus, method, program code, and system for correcting image distortions. In the disclosed embodiments, the electronic device includes an imaging device configured to obtain image data using a sensor and a lens that causes geometric distortion in the image data. In addition, the electronic device includes a geometric correction unit connected to an external memory which stores the image data as an array of distorted input sub-images, and which includes an internal memory and geometric distortion correction logic configured to correct for geometric distortion in the image data. To this end, the geometric distortion correction logic is configured to specify an input block having an adaptive size that is capable of storing up to a plurality of distorted input sub-images from the array of distorted input sub-images stored in external memory. In selected embodiments, the geometric correction unit specifies the input block by generating descriptor data for the input block. In other embodiments, the geometric correction unit specifies the input block by specifying a first input block having a fixed size that is sequentially applied to fetch adjoining groups of distorted input sub-images from external memory. In yet other embodiments, the geometric correction unit specifies the input block by specifying an adaptive size for a sequence of input blocks that are sequentially applied to fetch adjoining groups of distorted input sub-images from external memory with minimal overlap between different fetch operations. In addition, the geometric distortion correction logic is configured to fetch one or more first distorted input sub-images from the external memory using the input block to perform a single read operation. In selected embodiments, the geometric correction unit fetches one or more first distorted input sub-images by fetching multiple distorted input sub-images from external memory using the input block. In addition, the geometric distortion correction logic is configured to store the one or more first distorted input sub-images in the internal memory. In addition, the geometric distortion correction logic is configured to process the one or more first distorted input sub-images as a group for distortion correction to generate a one or more first corrected output tiles. In addition, the geometric distortion correction logic is configured to store the one or more first corrected output tiles in the external memory as corrected image data formed with an array of corrected output tiles. In selected embodiments, the geometric correction unit is embodied as image processing hardware unit having a control unit, and the internal memory is smaller than the external memory.

Those skilled in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. In addition, it will be appreciated that the various illustrative logical blocks, modules, circuits, and algorithm steps described in connection with the disclosure herein may be implemented as electronic hardware, computer software, or combinations of both. To illustrate clearly this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. The various illustrative logical blocks, modules, and circuits described in connection with the disclosure herein may be implemented or performed with dedicated distortion correction hardware, alone or in combination with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Although the described exemplary embodiments disclosed herein focus on grouping input sub-image read operations in a system and method for performing geometric distortion correction processing, the present invention is not necessarily limited to the example embodiments illustrate herein and may be applied to any image processing system that uses a tile-based approach to graphically process input image frames. Thus, the particular embodiments disclosed above are illustrative only and should not be taken as limitations upon the present invention, as the invention may be modified and practiced in different but equivalent manners apparent to those skilled in the art having the benefit of the teachings herein. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method of correcting image distortions in an image processing hardware unit that is connected to external memory which stores a geometrically distorted image as an input image frame that contains an array of source sub-images, the method comprising:
specifying an input block having a configurable size that is capable of storing up to a plurality of distorted input sub-images from the array of distorted input sub-images stored in external memory;
fetching one or more first distorted input sub-images from the external memory using the input block to perform a single read operation to fetch the one or more first distorted input sub-images;
storing the one or more first distorted input sub-images in internal memory of the image processing hardware; and
processing the one or more first distorted input sub-images as a group for distortion correction to generate a one or more first corrected output tiles.

2. The method of claim 1, where specifying the input block comprises generating descriptor data for the input block.

3. The method of claim 1, where specifying the input block comprises specifying an input block having a fixed size that is sequentially applied to fetch adjoining groups of distorted input sub-images from external memory.

4. The method of claim 1, where specifying the input block comprises specifying an input block having an adaptive size that is sequentially applied to fetch adjoining groups of distorted input sub-images from external memory with minimal overlap between different fetch operations.

5. The method of claim 1, where fetching one or more first distorted input sub-images comprises fetching multiple distorted input sub-images from external memory using the input block.

6. The method of claim 1, where fetching one or more first distorted input sub-images comprises fetching a largest single distorted input sub-images from external memory using the input block.

7. The method of claim 1, where processing the one or more first distorted input sub-images comprises remapping source data pixels in the one or more first distorted input sub-images as a single group for distortion correction.

8. An image processing system for correcting image distortions, comprising:
an external memory which stores a geometrically distorted image in a source frame as an array of distorted input sub-images, and which stores a corrected image in an output frame as an array of corrected output tiles; and
an image processing hardware unit connected to the external memory, the image processing hardware unit comprising a control unit and an internal memory that is smaller than the external memory,
wherein the control unit is configured to read source data from the source frame in external memory for storage in internal memory using an input read block having an adaptive size for retrieving up to a plurality of distorted input sub-images with a single read operation, and
wherein the control unit is configured to use the input read block to fetch and process one or more first distorted input sub-images as a group for distortion correction to generate a one or more first corrected output tiles for storage in the output frame of external memory.

9. The image processing system of claim 8, where the control unit is configured to specify the adaptive size of the input read block by generating descriptor data for the input read block.

10. The image processing system of claim 8, where the control unit is configured to specify the adaptive size of the input read block by specifying a fixed size for the input read block that is sequentially applied to fetch adjoining groups of distorted input sub-images from external memory.

11. The image processing system of claim 8, where the control unit is configured to specify the adaptive size of the input read block by specifying an input read block having an adaptive size that is sequentially applied to fetch adjoining groups of distorted input sub-images from external memory with minimal overlap between different fetch operations.

12. The image processing system of claim 8, where the control unit is configured to fetch multiple distorted input sub-images from external memory using the input read block.

13. The image processing system of claim 8, where the control unit is configured to fetch a largest single distorted input sub-images from external memory using the input read block.

14. The image processing system of claim 8, where the control unit is configured to process one or more first distorted input sub-images by remapping source data pixels in the one or more first distorted input sub-images as a single group for distortion correction.

15. An electronic device comprising:
an imaging device configured to obtain image data using a sensor and a lens that causes geometric distortion in the image data; and
a geometric correction unit connected to an external memory which stores the image data as an array of distorted input sub-images, the geometric correction unit comprising an internal memory and geometric distortion correction logic configured to correct for geometric distortion in the image data by:
specifying an input block having an adaptive size that is capable of storing up to a plurality of distorted input sub-images from the array of distorted input sub-images stored in external memory;
fetching one or more first distorted input sub-images from the external memory using the input block to perform a single read operation;
storing the one or more first distorted input sub-images in the internal memory;
processing the one or more first distorted input sub-images as a group for distortion correction to generate a one or more first corrected output tiles; and
storing the one or more first corrected output tiles in the external memory as corrected image data formed with an array of corrected output tiles.

16. The electronic device of claim 15, where the geometric correction unit comprises image processing hardware unit comprising a control unit and where the internal memory is smaller than the external memory.

17. The electronic device of claim 15, where the geometric correction unit specifies the input block by generating descriptor data for the input block.

18. The electronic device of claim 15, where the geometric correction unit specifies the input block by specifying a first input block having a fixed size that is sequentially applied to fetch adjoining groups of distorted input sub-images from external memory.

19. The electronic device of claim 15, where the geometric correction unit specifies the input block by specifying an adaptive size for a sequence of input blocks that are sequentially applied to fetch adjoining groups of distorted input sub-images from external memory with minimal overlap between different fetch operations.

20. The electronic device of claim 15, where the geometric correction unit fetches one or more first distorted input sub-images by fetching multiple distorted input sub-images from external memory using the input block.
